(19) United States
(12) Patent Application Publication
(10) Pub. No.: US 2008/0270262 A1
(43) Pub. Date: Oct. 30, 2008

(54) LOYALTY CARD BASED ALLERGY WARNING PROGRAM

(75) Inventors: Kaushik Subramanian, Fremont, CA (US); Stuart Aitken, Pleasanton, CA (US); Jonathan Quinn, San Mateo, CA (US)

Correspondence Address: CONLEY ROSE, P.C., 5601 GRANITE PARKWAY, SUITE 750, PLANO, TX, 75024, US

(73) Assignee: Safeway, Inc., Pleasanton, CA (US)

(21) Appl. No.: 11/749,671

(22) Filed: May 16, 2007

Related U.S. Application Data
(60) Provisional application No. 60/915,015, filed on Apr. 30, 2007.

(51) Int. Cl. G06Q 99/00

(52) U.S. Cl. 705/27

(57) ABSTRACT

The present application discloses systems and methods for managing nutritional information which in some embodiments comprises a database coupled to a central processor, a storage module configured to store in the database a plurality of records comprising loyalty card data for products purchased with a loyalty card and nutritional information for products available for purchase with the loyalty card, and a plurality of records relating to after sale product information. These systems and methods may further comprise a data processing module configured to compare products purchased with a loyalty card with the after sale product information, and determine if there are conflicts and an output module for transmitting results, wherein the central processor is configured to generate a report based upon the information found in the storage module.

### CROSS-REFERENCE TO RELATED APPLICATIONS

This application claims priority under 35 U.S.C. §119(e) to U.S. Provisional Patent Application Ser. No. 60/915,015 entitled “Loyalty Card Based Allergy Warning Program,” and filed on Apr. 30, 2007, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present invention relates to the creation of customized nutritional purchase information, and more specifically to the creation of nutritional reports, nutritional options, and promotional information based upon purchases at a local store or online store made while using a loyalty card.

### BACKGROUND

Loyalty cards are one way to offer incentives for consumers to return to a particular company. For instance, a store may reward its consumers with financial bonuses or discounts that may be applied to purchases. In addition to the enhanced consumer loyalty, the company obtains information on consumers' purchasing behavior.

While the information obtained on the consumers purchasing behavior is useful by the company, there has not been a way to provide the consumer with useful information based upon information that has been obtained. This problem is perhaps most evident in grocery stores, where nutrition information is freely available for individual products, but is not aggregated in a way that is useful to a consumer.

In addition, in grocery stores where food items are sold, there are times in which the status of products may change (e.g. recalled, health warnings issued, etc.) as well as some consumers may have allergic reactions to some products. In these situations, systems and methods that could alert the consumer to these changes and possible reactions would be desirable.

### SUMMARY

In one embodiment, a computerized method for consumer notification is disclosed which comprising providing a database coupled to a central terminal, storing in the database at least one loyalty profile, and storing in the database a plurality of records comprising products available for purchase using the loyalty profile. This method also comprises storing in the database a plurality of records comprising product status information for the products available for purchase using the loyalty profile, storing purchases made using the loyalty profile, and updating the product status information stored in the database. This method further comprises detecting a change in product status for products purchased using the loyalty profile, generating a report describing the change in the product status for products purchased using the loyalty profile, and transmitting the report to the loyalty profile or a consumer related to the loyalty profile.

In another embodiment, a computerized method for consumer notification is disclosed which comprises providing a database coupled to a central terminal, storing in the database a plurality of records comprising products available for purchase using a loyalty profile, and storing in the database a plurality of records comprising nutritional information related to products available for purchase using the loyalty profile. This method also comprises associating in the database the nutritional information with products purchased using the loyalty profile, storing in the database consumer information related to a consumer using the loyalty card, detecting conflicts between the consumer information and the products purchased using the loyalty profile, and transmitting a report the consumer who is related to the loyalty profile.

In yet another embodiment, a system for managing nutritional information is disclosed which comprises a database coupled to a central processor, a storage module configured to store in the database a plurality of records comprising loyalty card data for products purchased with a loyalty card and nutritional information for products available for purchase with the loyalty card, and a plurality of records relating to after sale product information. This method further comprises a data processing module configured to compare products purchased with a loyalty card with the after sale product information, and determine if there are conflicts and an output module for transmitting results, wherein the central processor is configured to generate a report based upon the information found in the storage module.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is an overview of one embodiment of the present disclosure.

FIG. 2 is a flowchart of one embodiment of the creation of a consumer profile.

FIG. 3 is a flowchart of one embodiment of the creation of a report based upon a consumer profile.

FIG. 4 is a flowchart of one embodiment of the creation of a customized report preference by a consumer.

FIG. 5 is an overview of another embodiment of the present disclosure.

FIG. 6 is a flowchart of one embodiment of a product status change notification.

FIG. 7 is a screenshot of a recall warning.

FIG. 8 is a flowchart of an allergy warning system.

FIG. 9 is a screenshot of an allergy warning.

FIG. 10 illustrates an exemplary general purpose computer system suitable for implementing the several embodiments of the disclosure.

### DETAILED DESCRIPTION

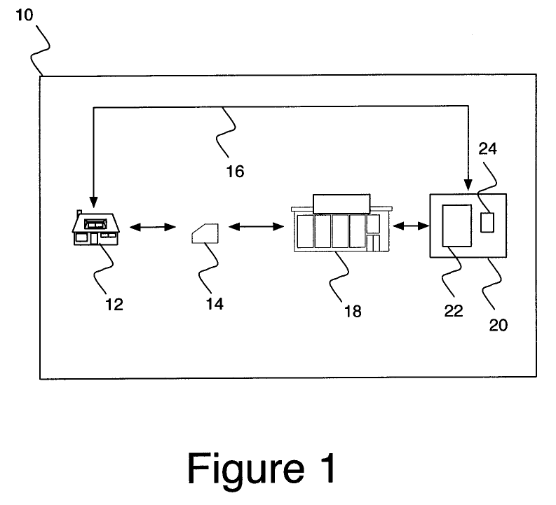

In an embodiment shown in FIG. 1, the loyalty card based allergy warning program 10 contains a consumer 12, a loyalty card 14, a network connection 16, a store 18, an informational computer 20, and an informational database 22. Consumer 12 registers a first loyalty card 14, for example using network connection 16, with informational computer 20 and creates a loyalty profile 24. Consumer 12 may add information during or after creation of loyalty profile 24 including, but not limited to, allergy information, medical information (e.g. blood pressure, specific medical problems, etc.), or other information known to consumer 12 to loyalty profile 24. Consumer 12 uses loyalty card 14 at store 18 while making purchases. Informational computer 20 records the purchases of consumer 12. Informational computer 20 is capable, in some embodiments, of detecting conflicts (e.g. the purchasing of a product to which consumer 12 has indicated an allergic reaction, or other preference to avoid) between information provided by consumer 12 and products purchased by consumer 12 using loyalty card 14. Informational computer 20 is also capable, in other preferred embodiments, of notifying consumer 12 in the change of product status (e.g. product recall) of items purchased using loyalty card 14. Informational computer 20 may create a report based upon the detection of a conflict, a report at the request of consumer 12, a report in response to the change in the product status by a manufacturer or other source, or a report for any other reason.

The report created by informational computer 20 is then transmitted through network connection 16 or otherwise conveyed to consumer 12. Network connection 16 may be any network capable of transmitting and receiving data including, but not limited to, Internet, postal, and telephone networks. It should be understood that the registration of loyalty profile 24 and the purchasing of products might be performed in any order or concurrently. It should also be understood that store 18 may be a local store, such as a grocery store which is intended to refer to any location physically visited by consumer 12, or an online store visited by consumer 12 through a computer terminal or other electronic device.

While FIG. 1 illustrates a single consumer 12, loyalty card 14, and store 18 it is envisioned that a plurality of consumers may use a plurality of loyalty cards at a plurality of stores linked to a single loyalty profile 24. It is further envisioned that informational computer 20 could use any number of stores to collect information about purchases of consumer 12. The examples of consumer 12, loyalty card 14, and store 18 are therefore intended to be illustrative and not limiting.

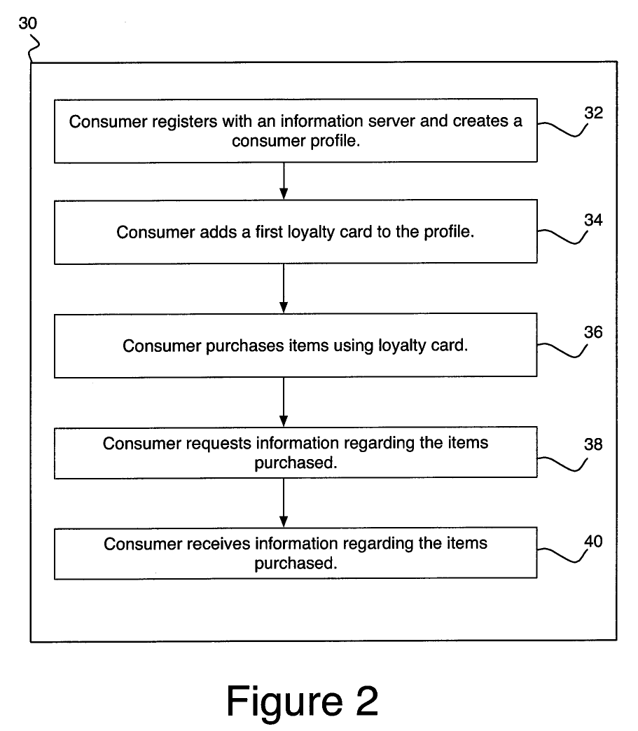

FIG. 2 is a flowchart 30 of one embodiment of the process by which consumer 12 may register one or more loyalty cards with informational computer 20 (Block 32). Consumer 12 communicates directly or indirectly with informational computer 20 and creates loyalty profile 24 through network connection 16. Loyalty profile 24 may include, but is not limited to the following information about individuals using loyalty profile 24: gender, name, age, allergies, weight, medical conditions, and activity level. Using the gender, name, age, allergies, weight, medical conditions, and activity level informational computer 20 is capable of determining the recommended daily intake for nutrients including, but not limited to, calories using industry accepted guidelines and other methods known to one skilled in the art as well as determining which nutrients consumer 12 should avoid. Two examples of industry accepted guidelines are the daily-recommended intake of calories as set by the Food and Drug Administration (FDA) and the United States Department of Agriculture (USDA) Dietary Guidelines. Consumer profile 24 also contains information regarding the identity and quantity of products purchased using loyalty card 14.

Consumer 12 can add a loyalty card 14 to the loyalty profile 24 (Block 34). In the example shown in FIG. 2, loyalty card 14 is registered using network connection 16. However, it is explicitly understood that loyalty card 14 could be registered in any number of other ways, including, but not limited to, filling out a registration form at store 18. It is further understood that store 18 may, in some alternative embodiments, directly input loyalty profile 24 into informational computer 20.

When consumer 12 purchases products from store 18 using loyalty card 14 linked to loyalty profile 24, informational computer 20 automatically updates loyalty profile 24 with purchases made with loyalty card 14 (Block 36). Consumer 12 can access informational computer 20 and request information about the products purchased through network 16 (Block 38). Consumer 12 can also receive information regarding the products purchased with loyalty card 14 (Block 40). The information received by consumer 12 may include, but is not limited to, information regarding nutritional information of products purchased, alternatives to products purchased, methods of preparation of products purchased, and other promotional or informational material. The information that consumer 12 receives may be transmitted via email, displayed on a local web browser, transmitted through telephonic communication (e.g., facsimile transmission), presented at a point of sale or purchase, or in other ways known to one skilled in the art.

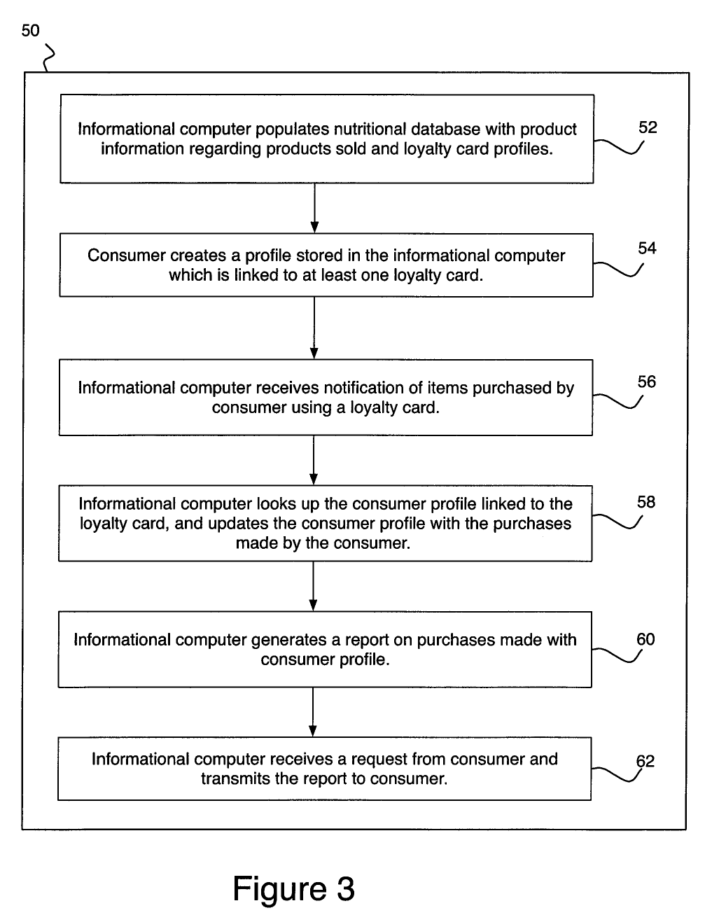

FIG. 3 is a flowchart 50 of one embodiment where informational computer 20 populates informational database 22 and creates a report for consumer 12. Informational computer 20 populates informational database 22 with product information regarding products sold at store 18 (Block 52). Manufactures, distributors, the USDA, the FDA, or any other source known to one skilled in the art may provide this information. Consumer 12 creates loyalty profile 24, which is stored in informational computer 20 and is linked to at least one loyalty card 14 (Block 54). Loyalty profile 24 may be created in any manner discussed above, and may be created prior, concurrent, or subsequent to the population of informational database 22. Informational computer 20 receives notification of items purchased by consumer 12 using loyalty card 14 (Block 56). Such notification may be made in any way known to one skilled in the art, including, but not limited to, point of sale data. This data could, in one embodiment, be obtained through collecting data from the scanning of items sold, capturing this data, and transmitting this data to informational computer 20. Informational computer 20 looks up the loyalty profile 24 linked to loyalty card 14, and updates loyalty profile 24 with information related to the purchases made by consumer 12 (Block 58). This purchasing information may include, but is not limited to, the type and quantity of products purchased, information identifying loyalty card 14, and other sales information. Informational computer 20 generates a report on purchases made by consumer 12 using the loyalty profile 24 (Block 60). It is expressly contemplated that consumer 12 may modify consumer profile 24 with additional products purchased, or by removing items listed in loyalty profile 24. In this embodiment, informational computer 20 automatically generates a report upon the receipt of information by store 18; however, it is contemplated that the report may be generated at any time as discussed above. When informational computer 20 receives a request from consumer 12 linked to loyalty profile 24, it transmits the report based on loyalty profile 24 to consumer 12 (Block 62).

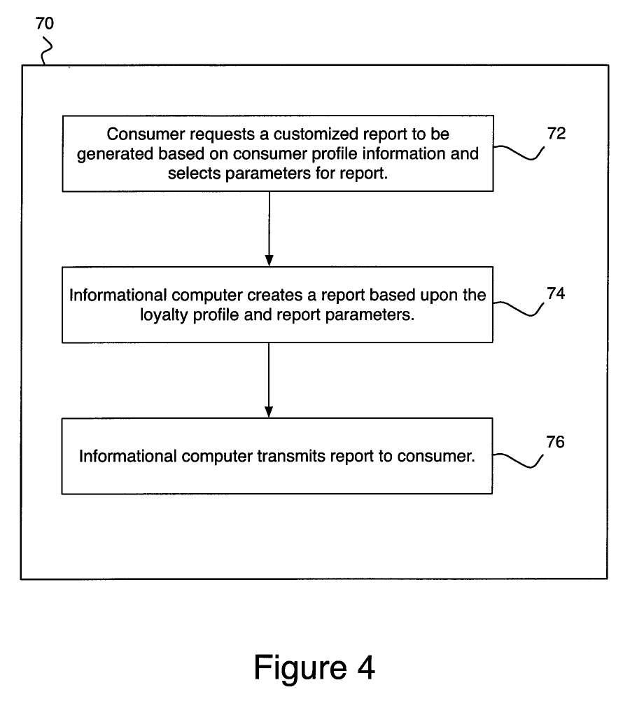

FIG. 4 is a flowchart 70 of one embodiment where a consumer can create a customized report to determine if purchased items might cause allergic reactions. First, the consumer requests a customized report to be generated based on consumer profile information, and selects parameters for the report (Block 72). Parameters for the report include, but are not limited to, the purchased products consumer 12 is interested in (e.g. breads, fruits, and candy), the product status for each product consumer 12 is interested in, and any known allergic reaction that may occur given the items purchased and loyalty card profile 24. Informational computer 20 creates a report based upon the loyalty profile 24 and report parameters (Block 74). Informational computer 20 transmits the report to consumer 12 (Block 76).

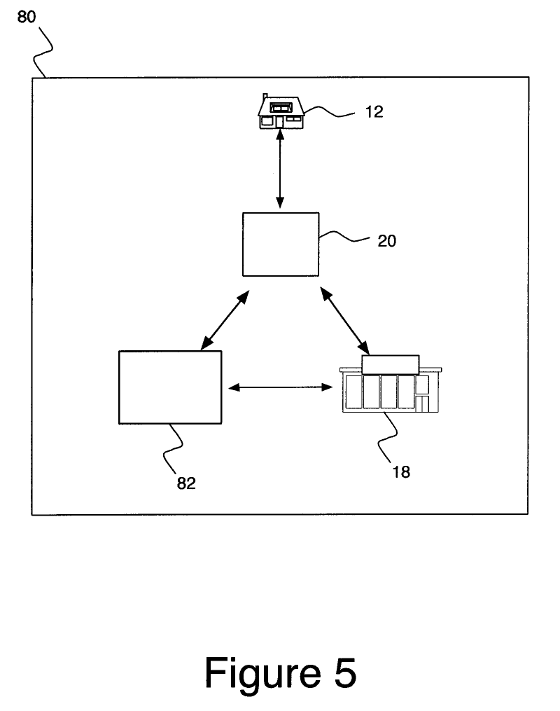

FIG. 5 is an overview 80 of one embodiment that integrates a product status computer 82 with informational computer 20, store 18, and consumer 12. In this embodiment, informational computer 20 is capable of communicating with consumer 12, store 18, and product status computer 82. Product status computer 82 is further capable of communication with store 18. In some embodiments, the product status computer 82 is capable of providing information regarding the product status (e.g. recall, consumer advisory, etc.) of items sold in store 18. Product status computer 82 may receive information from any number of sources, including but not limited to, the FDA, manufacturers, or other entities. In the event of the change of a product status, product status computer 82 transmits the product status change to informational computer 20, store 18, or both informational computer 20 and store 18. For example, in the event of a recall, product status computer 82 transmits information to store 18 and informational computer 20 regarding the recall of products. Informational computer 20 then is capable, in some embodiments, of forwarding this information to consumer 12.

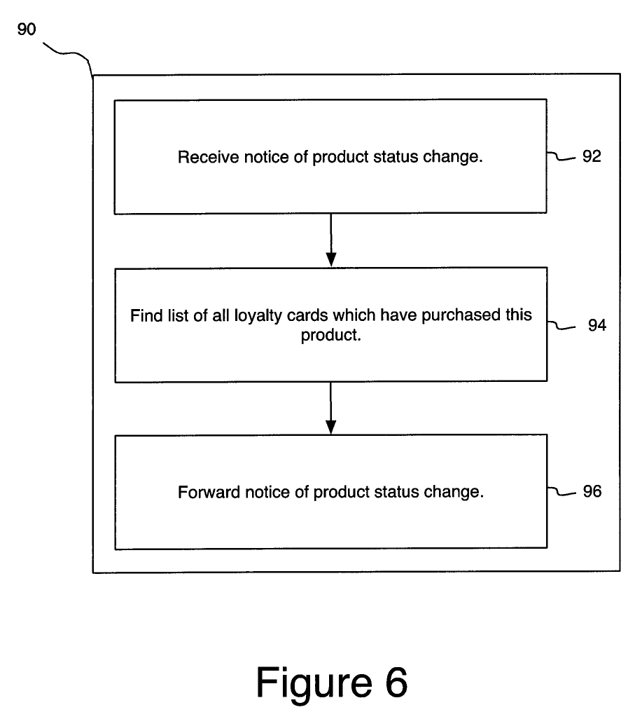

FIG. 6 is a flowchart 90 of steps by which the status of a product may be changed and transmitted to consumer 12. In this example embodiment, informational computer 20 receives notice of a product status change from the product status computer 82 (Block 92). Informational computer 20 then finds a list of all loyalty cards and loyalty card profiles that have been used during the purchasing of the item for which the product status has changed (Block 94). Finally, informational computer 20 will forward a notice of the product status change to consumer 12 (Block 96).

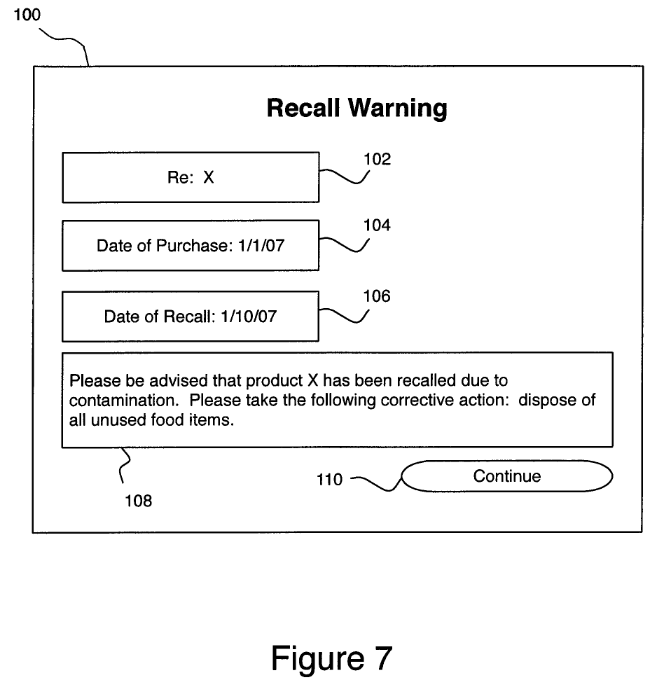

FIG. 7 is an example of a screenshot 100 of a product recall warning. In this example screenshot, the name of product being recalled 102, the date the item was purchased 104, and the date of the recall 106, an explanation of the recall 108 is shown. It is expressly understood that the explanation for the recall 108 may, in some embodiments, be a forwarded recall notice from the manufacturer. This notice may also contain a continue 110 button which, when pressed, may be recorded by informational computer as an acknowledgement that information regarding the recall was acknowledged by consumer 12.

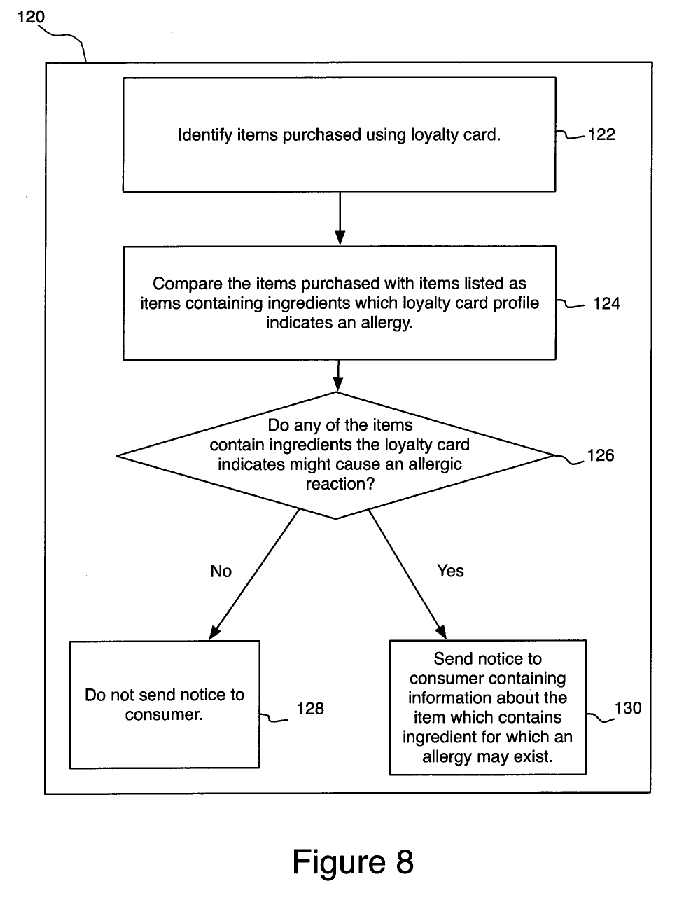

FIG. 8 is a flowchart 120 of one method alerting consumer 12 to a possible allergy conflict. In this flowchart, informational computer 20 identifies items purchased using a loyalty card (Block 122). Informational computer 20 compares items purchased with items listed as items containing ingredients which loyalty card profile 24 indicates an allergy (Block 124). Informational computer 20 then determines if any of the items contain ingredients the loyalty card profile 24 indicates might cause an allergic reaction (Block 126). If none of the items contain ingredients that loyalty card profile 24 indicates an allergy exists for, then informational computer 20 does not send a notice to the consumer (Block 128). If an item contains an ingredient that loyalty card profile 24 indicates an allergy exists for, then informational computer 20 sends a notice to consumer 12 containing information about the item that contains the ingredient that may cause an allergic reaction (Block 130). This notice may contain information including the steps, as provided by a third party source such as the FDA, to take in the event that the food is ingested.

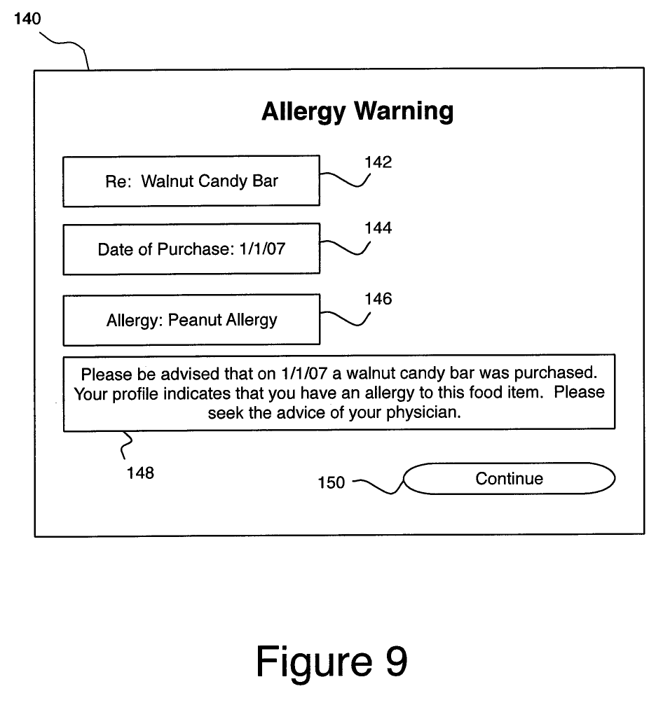

FIG. 9 is a screenshot 140 of an allergy warning issued by informational computer 20. The allergy warning contains the name of the item to which there is a possible allergy 142, the date of purchase of the item 144, the name of the allergy 146 indicated by consumer 12, and a warning 148. This warning may include information regarding the appropriate steps as provided by a third party in the case of the ingestion of the food item. This notice may also contain a continue 150 button which, when pressed, may be recorded by informational computer as an acknowledgement that information regarding the recall was acknowledged by consumer 12. Consumer 12 is therefore alerted to consumer information regarding what types of food products may be undesirable.

Alerts may be given to consumer 12 for any undesirable product. Undesirable products are determined by any standard desired by the consumer, including, but not limited to, allergies, other types of heath concerns (e.g. cholesterol), or health goals (e.g. weight loss).

The examples of the allergy and product status changes are intended to be illustrative only. Embodiments explicitly envisioned include any notification of any kind issued to consumer 12 or other individual or entity regarding information about the products purchased by consumer 12, or new information obtained by informational computer 20 after the sale of items to consumer 12. Additional examples include, but are not limited to, the discontinuation of certain items, change in side effects of different drugs sold by a pharmacy, the change in the warnings of drugs sold (e.g., additional warnings during pregnancy, etc.), advantages of certain products, or any other product information provided to consumer 12. In this way, the disclosed systems and methods are not limited to warning consumer 12 about products purchased by consumer 12, but can also alert consumer 12 to some advantages of products available for purchase or purchased by consumer 12.

Examples of advantages include, but are not limited to, health qualities (e.g. antioxidant qualities, concentration of certain vitamins, concentration of fiber, etc.), promotion offers, or other information given to consumer 12. Such advantages may be programmed into informational computer 20 in any way known to one skilled in the art.

Moreover, it is explicitly understood that any source (i.e. physician, hospital, health care provider, etc.) may add, in some embodiments, information to consumer profile 24. In this way, a third party such as a physician may add additional information regarding the desirability or potential harm of certain food items purchased by consumer 12. This information may include the avoidance of certain items (e.g., for an individual who has suffered a heart attack, the physician may indicate that all high fat products must be avoided). In this way, informational computer 20 may aggregate information from any number of sources to create customized reports for consumer 12.

Another innovative embodiment of the present disclosure is the ability to store consumer profile 24, part of consumer profile 24 and a unique identifying code corresponding to consumer profile 24, or only a unique identifying code corresponding to consumer profile 24 on any computer identifiable mechanism. The phrase “computer identifiable mechanism” is intended to include, but not be limited to, any type of storage device that may store any kind of identification information which may be read by or transmitted to informational computer 20. Examples of computer identifiable mechanisms which may be used consistent with the present disclosure include, but are not limited to, bar codes, information embedded in a magnetic strip, information embedded in memory device such as a flash memory device. The unique identifying code may be any piece of unique information, including, but not limited to, a phone number, a unique combination of letters or numbers, or a unique code stored on a computer readable mechanism.

It is expressly contemplated that information stored in the computer identifiable mechanism may, in some embodiments, be transmitted over the air through a communication mechanism (e.g., radio frequency identification (RFID)), be read by a magnetic card reader, entered manually by consumer 12, or conveyed in any other way known to one skilled in the art. It is further contemplated that, in some embodiments, a third party may access informational computer 20 to obtain information about consumer 12. Examples of third parties include, but are not limited to, restaurants, convenience stores, or any other entity which may sell items that consumer 12 may consume.

Another of the innovations made possible through the present disclosure and the computer identifiable mechanism is the ability to control what information consumer 12 makes available to a third party. For instance, in the example of the RFID example, consumer 12 may wish to allow a third party computer to be aware of an allergy. In this example, if consumer 12 were to go to a store equipped with the mechanism to read from the computer identifiable mechanism, and consumer 12 were to purchase an item to which an allergy or other warning had been stored in computer identifiable mechanism, the third party could warn consumer 12 of the possible conflict.

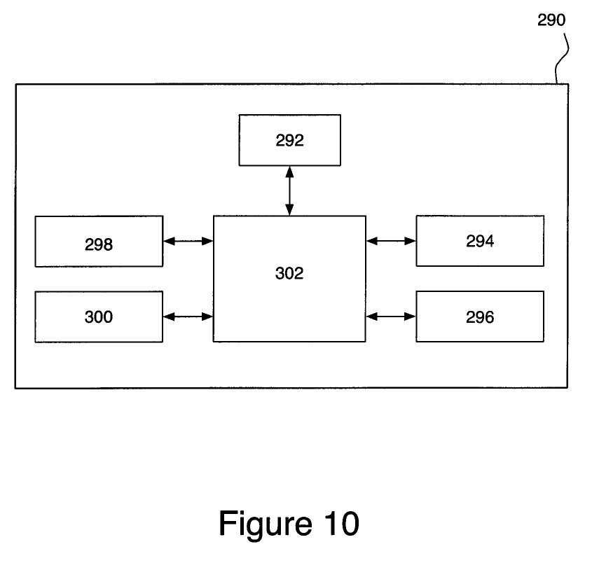

Informational computer 20 described above may be implemented on any general-purpose computer 290 with sufficient processing power, memory resources, and network throughput capability to handle the necessary workload placed upon it. A user home personal computer, networked to a central informational computer 20 through a wide area network, such as the Internet, may be used in conjunction with the disclosed embodiments. The user home personal computer may share some, or all, of the elements of informational computer 20. FIG. 10 illustrates a typical, general-purpose computer system suitable for implementing one or more embodiments disclosed herein. The general-purpose computer 290 includes a processor 302 (which may be referred to as a central processor unit or CPU) that is in communication with memory devices including secondary storage 292, read only memory (ROM) 294, random access memory (RAM) 296, input/output (I/O) 298 devices, and network connectivity devices 300. The processor may be implemented as one or more CPU chips.

The secondary storage 292 is typically comprised of one or more disk drives or tape drives and is used for non-volatile storage of data and as an over-flow data storage device if RAM 296 is not large enough to hold all working data. Secondary storage 292 may be used to store programs that are loaded into RAM 296 when such programs are selected for execution. The ROM 294 is used to store instructions and perhaps data that are read during program execution. ROM 294 is a non-volatile memory device that typically has a small memory capacity relative to the larger memory capacity of secondary storage. The RAM 296 is used to store volatile data and perhaps to store instructions. Access to both ROM 294 and RAM 296 is typically faster than to secondary storage 292.

I/O 298 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 300 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity devices 300 may enable the processor 302 to communicate with an Internet or one or more intranets. With such a network connection, it is contemplated that the processor 302 might receive information from the network, or might output information to the network in the course of performing the above-described method steps. Such information, which is often represented as a sequence of instructions to be executed using processor 302, may be received from and outputted to the network, for example, in the form of a computer data signal embodied in a carrier wave.

Such information, which may include data or instructions to be executed using processor 302 for example, may be received from and outputted to the network, for example, in the form of a computer data baseband signal or signal embodied in a carrier wave. The baseband signal or signal embodied in the carrier wave generated by the network connectivity devices 300 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 302 executes instructions, codes, computer programs, scripts that it accesses from hard disk, floppy disk, optical disk (these various disk based systems may all be considered secondary storage 292), ROM 294, RAM 296, or the network connectivity devices 300.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

What we claim as our invention is:

1. A computerized method for consumer notification, the method comprising:
providing a database coupled to a central terminal;
storing in the database a profile corresponding to a consumer;
storing in the database a plurality of records comprising products available for purchase using the loyalty profile;
storing in the database a plurality of records comprising product status information about the products available for purchase using the loyalty profile;
storing products purchased using the loyalty profile;
updating the product status information stored in the database;
detecting a change in the product status for the products purchased using the loyalty profile;
generating a report describing the change in the product status for the products purchased using the loyalty profile; and
transmitting the report to the consumer.

2. The method of claim 1, wherein the transmitting of the report is through postal mail, Internet, or facsimile transmission.

3. The method of claim 1, wherein the change in product status is a product advisory or a product recall.

4. The method of claim 3, wherein the report contains the text of the product advisory or product recall.

5. The method of claim 4, further comprising recording confirmation of receipt of the report.

6. The method of claim 1, wherein product status information is updated by the manufacturer.

7. The method of claim 5, wherein the report is transmitted to multiple locations.

8. A computerized method for consumer notification, the method comprising:
providing a database coupled to a central terminal;
storing in the database a plurality of records comprising products available for purchase using a loyalty profile;
storing in the database product purchased records using the loyalty profile;
storing in the database a plurality of nutritional information records related to the products available for purchase using the loyalty profile;
associating in the database the nutritional information records with products purchased records using the loyalty profile;
storing in the database undesirable consumer product information for the consumer using the loyalty profile;
detecting matches between the undesirable consumer product information and the products purchased using the loyalty profile; and
transmitting a report indicating the detected matches to the consumer who is related to the loyalty profile.

9. The method of claim 8, wherein the consumer information includes medical information, allergies, or information entered into the database by a third party.

10. The method of claim 9, further comprising storing in the database a plurality of records comprising third party recommendations related to products available for purchase using a loyalty profile.

11. The method of claim 10, wherein the third party recommendations are obtained by the Food and Drug Administration, United States Department of Agriculture, or American Medical Association.

12. The method of claim 8, wherein matches are determined by any item purchased using the loyalty profile matching an item that the consumer has specified a preference to avoid.

13. The method of claim 12, wherein matches are determined by any item purchased using the loyalty profile matching an item that is known to trigger an allergy the consumer has specified.

14. The method of claim 8, wherein the report contains information regarding the ingredients of the products purchased which created the conflict.

15. The method of claim 8, wherein the report is transmitted to the consumer through postal mail, Internet, or facsimile transmission.

16. The method of claim 8, wherein the report is transmitted to a third party.

17. A system for managing nutritional information, the system comprising:
a database coupled to a central processor;
a storage module configured to store in the database a plurality of records comprising loyalty card data for products purchased with a loyalty card, nutritional information for products available for purchase with the loyalty card, and a plurality of records relating to after sale product information;
a data processing module configured to compare products purchased with a loyalty card with the after sale product information, and to determine if there are conflicts; and
an output module for transmitting results, wherein the central processor is configured to generate a report based upon the information created in the data processing module.

18. The system of claim 17, wherein the after sale product information is a product recall.

19. The system of claim 17, further comprising a consumer information module for storing consumer information.

20. They system of claim 19, wherein the data processing module determines conflicts by comparing the information of the storage module and the consumer information module.
